(19) United States
(12) Patent Application Publication
(10) Pub. No.: US 2003/0061361 A1
(43) Pub. Date: Mar. 27, 2003

(54) System and methods for automatic negotiation in distributed computing

(76) Inventors: Roman Bacik, Vancouver (CA); Ryan Chapman, Vancouver (CA); Graham Smith, Coquitlan (CA)

Correspondence Address: OYEN, WIGGS, GREEN & MUTALA, 480 - THE STATION, 601 WEST CORDOVA STREET, VANCOUVER, BC, V6B 1G1, CA

(21) Appl. No.: 10/085,024

(22) Filed: Mar. 1, 2002

(30) Foreign Application Priority Data
Sep. 13, 2001 (CA) 2,357,444

(51) Int. Cl. G06F 15/16

(52) U.S. Cl. 709/228; 709/202

(57) ABSTRACT

This invention provides a methodology for negotiating parameters in a distributed computing environment. The invention may be implemented in a way which is simple, general and robust. Leasing, deadlock detection and starvation detection may be provided. The invention may be applied to automatic configuration of networked devices and their services. In one embodiment, devices on a computer network provide services. In each instance where one service imports functionality from another service a finite state machine associated with each service is instantiated. The finite state machines exchange messages which cause them to progress through a sequence of states. The messages contain configuration data. When the finite state machines have reached their final states the functionality in question is made available to the importing service. The finite state machines enforce incremental negotiation. The finite state machines also provide smooth recovery from errors and interruptions in network availability.

### TECHNICAL FIELD

This invention relates to distributed computation and to data communication networks on which distributed computation is performed. The invention relates generally to the negotiation of parameters between different communicating entities. The entities may be devices, or components of devices, which communicate with one another. The invention may be applied to the configuration of networked devices to permit the devices to work in cooperation with one another. Some aspects of the invention have particular application to internet protocol (IP) networks.

### BACKGROUND

In distributed computing, different entities, may be required to negotiate parameters with one another. The parameters may represent resources, requirements, data on which computations are to be based, or the like. A typical negotiation progresses through a number of stages. Each stage involves the exchange of one or more parameters between the negotiating entities. If the negotiation is successfully concluded then, at the end of the negotiation, at least one of the entities will have obtained from the other a set of one or more parameters required or useful for performing some function.

One example of distributed computing is the configuration of networked devices. A typical computer network includes a number of devices which can communicate with one another using one or more communication protocols. The network may be a wired network, in which data is carried between the devices by electrical wires or optical fibers. The network may also be a wireless network, in which data is carried by way of signals which pass through the air. A wireless network may use radio signals, infrared signals or even sonic signals to carry data between devices.

Each device on a network typically has an address which other devices can use to direct communications to it. When a new device is added to a network then the device must typically be configured to work in the network. Reconfiguration may be required if networked devices are moved from place to place. Configuration (or reconfiguration) typically involves setting parameters such as: IP addresses, host names, domain names, router addresses, gateway addresses, name server addresses. Configuration may also involve configuring a hardware or software firewall to allow data required for operation of the new device to pass through the firewall. Firewall configuration may require specific ports or protocols to be enabled in the firewall. Configuration may also involve setting parameters to permit secure access to network resources.

Today's devices communicate with other devices in sophisticated ways which can require complicated configuration. According to the current state of the art, with the limited exception of IP addresses, which are discussed below, configuration is generally performed manually. While this is a complex and time consuming task in networks of all sizes, it is particularly troublesome in managing small home or office networks where dedicated configuration staff are not available.

There have been various attempts to provide distributed systems in which parameters are negotiated automatically between different entities. One approach to the negotiation of parameters between entities is to create application-specific software which can be executed at each entity. The application-specific software coordinates negotiation of the required parameters. The inventors have recognized that this approach is inefficient because software must be written specifically to handle each negotiation. Apart from being expensive and time consuming, this increases the risk that the software may include errors which make systems which include such software less robust than would be desired.

Application-specific hardware may also be provided. This tends to involve undesirably large development costs and is typically not flexible enough to accommodate change.

There are various examples of application-specific software for making networks and networked devices self-configuring, to at least some degree. For example, Horie et al. U.S. Pat. No. 5,991,828 discloses a method for automatically setting address information and network environment information in portable devices which may be added to a computer network. The information to be set for each device can include an IP address, host name, IP address of a gateway, sub-net mask information etc. In the Horie et al. system, a “setting device” manages addresses etc. on the network. When a device (a “setting-needed” device) is first added to the network it sends out a message requesting address information and network environment information. The setting device generates a reply which contains the required information. The setting-needed device then stores this information so that it can operate. The Horie et al. system is specifically directed to setting addresses and network environment information.

Krivoshein et al., U.S. Pat. No. 5,980,078 discloses a process control system for use, for example, in a chemical plant. The system includes a network to which specialized process-related digital devices can be connected. The devices may include controllers for valves, motors, and the like. The network includes a control device which provides a newly-connected device with initial information sufficient to communicate with the control system. The connected device can then upload device information and control parameters to the control system. A user can then commission the connected device by configuring the device to operate within the overall control scheme of the digital control system. This system requires a user to actively participate in the commissioning of each device.

There have been other attempts to provide systems which can be used as frameworks for developing distributed systems. Some examples of these systems are described below. In general, these systems require expert developers to develop the systems in question. The resulting systems are not automatically robust.

Adije-Winoto The design and implementation of an intentional naming system Operating Systems Review 34(5):186-201, December, 1999, discloses a proposed resource discovery and service location system suitable for use on dynamic and mobile networks of devices and computers. The system provides a language which allows nodes that provide a service to describe the service they provide and nodes which require services to describe the services that they require. A number of resolvers receive periodic advertisements from services to discover names.

Microsoft's “Universal Plug and Play” (UPnP) architecture (described at http://www.upnp.org). Describes an infrastructure in which devices each have a Dynamic Host Configuration Protocol (DHCP) client. The DHCP client permits the device to receive an Internet Protocol (IP) address from a DHCP server when the device is first connected to the network. UPnP provides mechanisms for devices to discover services available on a network and to exchange information specific to those services.

Sun's Jini™ technology (as described, for example, in JINI Architectural Overview—Technical White Paper Sun Microsystems Inc., 1999 which is available on the Internet at the URL http://www.sun.com/jini/whitepapers/architecture.pdf) provides an infrastructure based upon JAVA for allowing services and clients to discover and connect with one another. The network has one or more lookup services. When a service is plugged into a network of Jini technology-enabled services and/or devices, it advertises itself by publishing a Java programming language object that implements the service API. This object's implementation can work in any way the service chooses. The client finds services by looking for an object that supports the API. When it gets the service's published object, it will download any code it needs in order to talk to the service, thereby learning how to talk to the particular service implementation via the API.

Infrastructures such as UPnP, JINI and the intentional naming system described by Adije-Winoto make configuration tasks easier but do not eliminate them.

A problem with some prior self-configuring systems is that, under various circumstances, contention between various services for resources can cause one or more services to be starved for resources and unable to function properly or at all. Deadlock situations in which a group of two or more services each require access to resources provided by other ones of the group of two or more services can also occur. In such cases a network device can “hang” and fail to work properly.

A problem with some self-configuring systems is that they are too specific. While systems like DHCP permit the dynamic allocation of IP addresses they are not able to configure other resources on a computer system.

There is a need for a general system and methods for facilitating negotiations in a distributed computing environment. There is a particular need for such systems which are robust. One area in which this need is strong is in the field of configuring network services. There is a particular need for such methods which are general and provide for substantially complete automatic configuration.

### SUMMARY OF THE INVENTION

This invention provides methods and apparatus for conducting negotiations in distributed computing environments. Some specific embodiments of the invention provide methods and apparatus for negotiating the provision of functionality by one service to another service. While the invention has useful application in the field of configuring computer networks its application is not limited to this field. The invention may be used in the automatic configuration of any kind of service which provides functionality to another service and, more generally as a framework for negotiating parameters or resources in distributed systems.

Accordingly, one aspect of the invention provides a computer-implemented method for conducting a negotiation. The negotiation comprises an exchange of messages between first and second entities. The method comprises providing a finite state machine associated with the first entity, the finite state machine having a plurality of states; maintaining the finite state machine in one of its states matching a stage of a negotiation between the first and second entities; and, at the first entity conducting a negotiation with the second entity by exchanging messages with the second entity, each of the messages comprising an external aspect containing information determined by a current state of the finite state machine and an internal aspect. Preferred embodiments of the method include receiving at the first entity a message from the second entity, the message comprising an external aspect and an internal aspect and providing the external aspect of the message as input to the finite state machine.

In specific embodiments of the invention the first and second entities may comprise two services on a computer network and the negotiation may involve the exchange of parameters to permit one of the services to provide functionality to the other one of the services.

Preferably the finite state machine has a set of transition functions:

δ(q₀, ε)=q₀;

δ(q, ε)=q−2 if 2≦q;

δ(q, m)=m+1 if 0≦m≦q+1 and m≦2n;

δ(q, m)=q otherwise;

λ(q₀, ε)=q₀;

λ(q, ε)=q−2 if 2≦q.

λ(q, m)=m+1 if 1≦m≦q+1 and m≦2n; and,

λ(q, m)=ε otherwise

with Q=Σ=Δ={0, 1, . . . , 2n+1}

where Q is a finite set of states, q₀ is an initial one of the Q states, Σ is a finite input alphabet, Δ is an output alphabet; δ: Q×Σ→Q is a transition function, λ is a mapping from Q×Σ to Δ and ε represents an empty input.

In preferred embodiments the method includes periodically providing an ε input to the finite state machine. This may be used to provide a leasing mechanism.

Another aspect of the invention relates to a method performed in a computer system comprising a plurality of entities including first and second entities and one or more data communication channels by way of which the entities can exchange messages with one another. The method permits the first entity to obtain a sequence of sets of one or more parameters from the second entity. The method comprises:

a) providing first and second finite state machine at the first and second entities respectively, each of the finite state machines having a plurality of states including an initial state and a final state;

b) setting a current state of the first finite state machine to the initial state;

c) generating a message comprising an external aspect and an internal aspect, the external aspect determined by the current state of the finite state machine, the internal aspect containing information specifying a next set of required parameters; and,

d) sending the message to the second entity.

Preferably the method comprises subsequently receiving at the first entity a response message from the second entity. The response message comprises both an external aspect and an internal aspect. The external aspect is determined by a current state of the second finite state machine. The internal aspect comprises the next set of required parameters. The method comprises providing the external aspect of the response message as input to the first finite state machine and passing the internal aspect of the message to a computational part of the first entity.

A yet further aspect of the invention provides a networkable device comprising a service and a resource allocation component. The resource allocation component comprises a finite state machine having a plurality of possible states including an initial state and a final state. The resource allocation component is configured to make available a resource to the service when the finite state machine is in the final state.

Yet another aspect of the invention provides a resource allocation component for networking a device on a data communication network. The resource allocation component comprises a service cache and a finite state machine corresponding to a service of the device. The finite state machine has a plurality of possible states including an initial state and a final state. The resource allocation component is configured to move the finite state machine to another state upon receiving a message from a corresponding finite state machine and moving the finite state machine to a final state upon receiving a message confirming the availability of a resource needed by the service.

Further features and advantages of the invention are set out below.

### BRIEF DESCRIPTION OF THE DRAWINGS

In Figures which illustrate non-limiting embodiments of the invention,

FIG. 1 is a schematic view of an example computer network according to the invention;

FIG. 2 is a block diagram of certain components of a networkable device according to the invention;

FIG. 3 is a block diagram of elements of a core;

FIG. 4, illustrates states through which two finite state machines pass while conducting a negotiation for the provision of functionality by a service exporting functionality to another service importing the functionality; and,

FIG. 5 illustrates a general negotiation process according to the invention.

### DESCRIPTION

Throughout the following description, specific details are set forth in order to provide a more thorough understanding of the invention. However, the invention may be practiced without these particulars. In other instances, well known elements have not been shown or described in detail to avoid unnecessarily obscuring the invention. Accordingly, the specification and drawings are to be regarded in an illustrative, rather than a restrictive, sense.

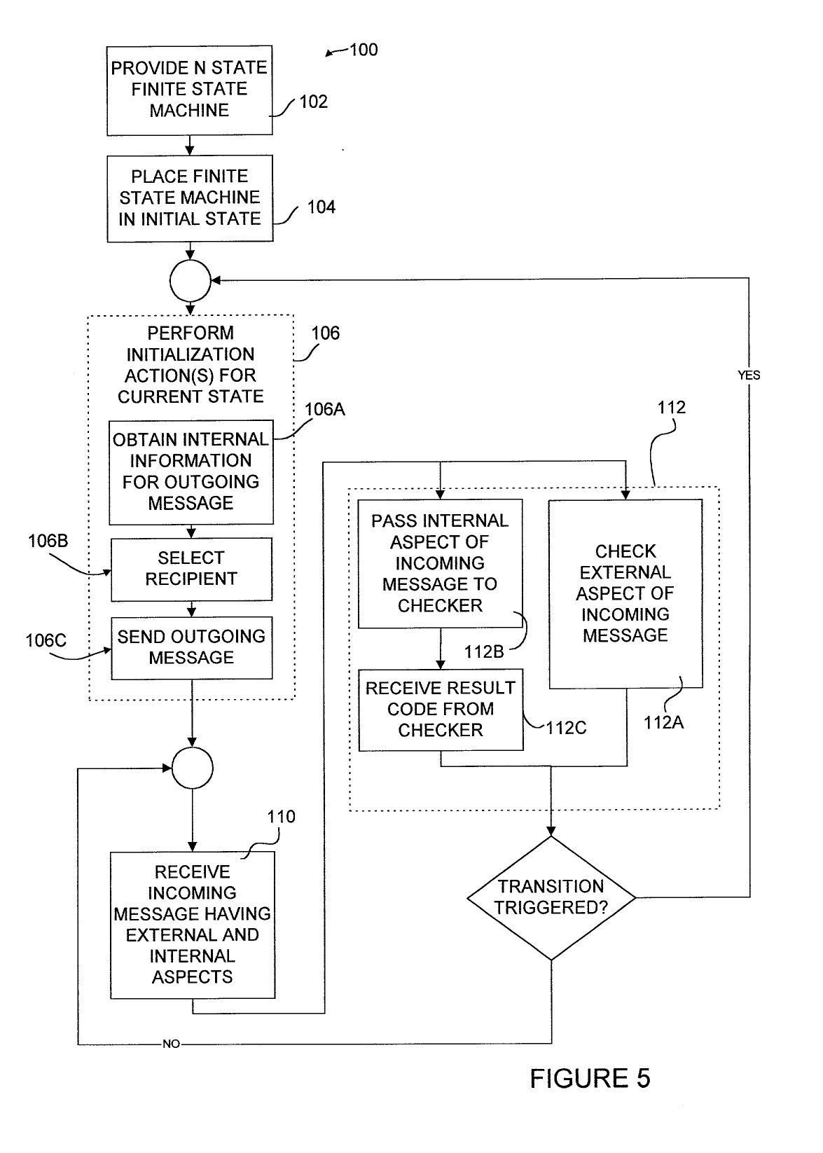

This invention has general application to the facilitation of negotiations of parameters (including resources) in distributed computing systems. The following description begins by describing an example a system in which the invention is applied to the configuration of services in a computer network. The invention is not limited to the configuration of network services. A more general discussion of the invention is described below with reference to FIG. 5.

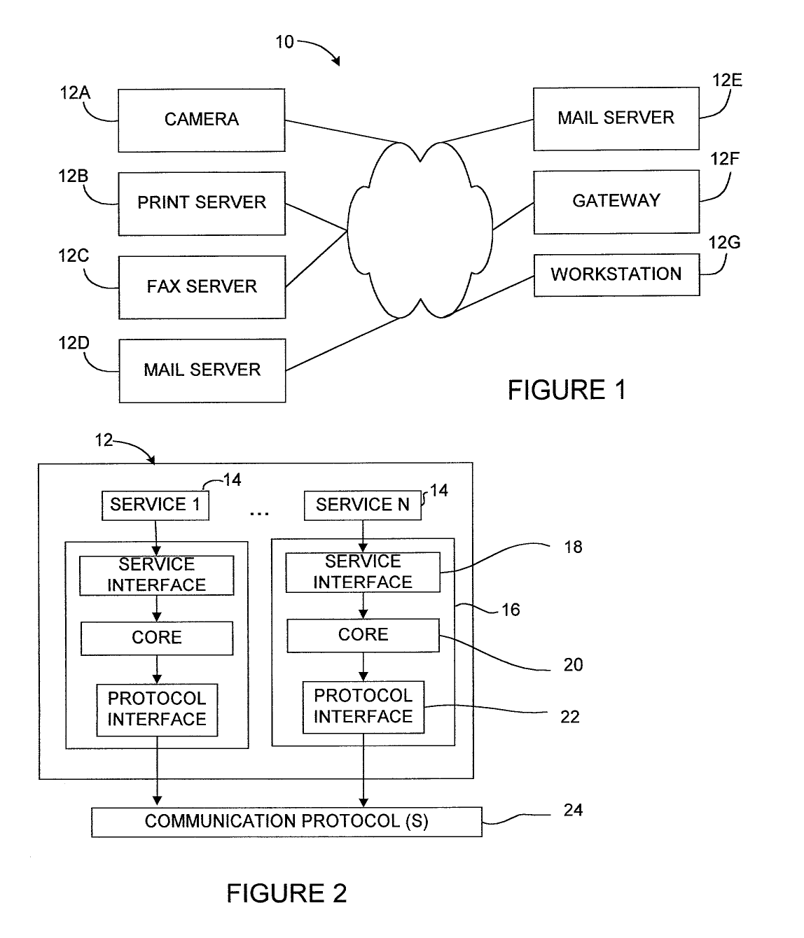

FIG. 1 shows a simple computer network 10 according to the invention which permits communications between a number of devices 12A through 12G. Network 10 carries data by way of one or more suitable communication protocols. The protocols may be currently known and used protocols such as TCP/IP, higher level protocols as specified by Microsoft™ Plug and Play or Sun™ JINI™ but the invention is not limited to such protocols. Other protocols may also be used. The network may be wired or wireless and may use any technology for carrying messages between devices 12A through 12G.

Various services 14 reside on network 10. In general, a service is something that, on request, can provide certain functionality or information by way of network 10. For example, DNS, DHCP and HTTP are services. A service is typically implemented by providing a software component which runs on a processor, which may be a general purpose processor or an embedded processor, in a network-connected device. In this invention services are preferably implemented in a manner which exports methods, events and properties. One can execute methods, to access parameters and to subscribe to events that the service provides. The collection of methods events and properties provided by a service may be called the functionality of the service. For a service to work properly, it must be properly configured. Configuration involves setting one or more configuration parameters of the service.

This invention may be applied to extend the functionality provided by existing services or to provide new services in order to allow devices to configure themselves and to assist in the configuration of the rest of network 10. This process may be viewed as the negotiation and leasing of configuration resources between peers.

Each of devices 12A through 12G (such devices are referred to generally as devices 12) provides one or more services 14. Functionality provided by one of services 14 may be used by other services on network 10. To make network 10 self-configuring, each such device 12 is structured as illustrated in FIG. 2. Each service 14 is associated with a configuration assistant component (CAC) 16. CAC 16 provides an extension to the service which facilitates the automatic configuration of the associated services. CAC 16 provides a mechanism whereby the service 14 can obtain information from other services 14 regarding the values that its own configuration parameters should have to permit the service to work properly together with the rest of network 10. CAC 16 also provides a mechanism for assisting other services 14 associated with other CACs 16 to obtain values for their own configuration parameters. The same type of CAC 16 may be used for any service 14. CAC's 16 separate the formal aspect of conducting negotiations related to the provision of functionality from technical details regarding the functionality which is the subject of the negotiation.

CAC 16 comprises a service interface 18, a core 20, and a protocol interface 22. Service interface 16 passes messages from service 14 to core 20 for communication to other devices and directs messages received by core 20 from other services 14 to the service 14 associated with the CAC 16. Service interface 18 may also provide a layer of translation between the messages used by each service and standardized messages which core 20 is able to deal with. If so, this part of service interface 18 is specific to particular services 14.

Protocol interface 22 directs communications to other services 14 by way of one or more protocols 24. Protocol interface 22 also receives messages from one or more protocols 24 and directs them to core 20.

Core 20 manages the import and export of configuration information relating to the associated service 14. Preferably all cores 20 are substantially the same. A main purpose of core 20 is to configure services 14. Configuring a service typically involves a negotiation process during which the service secures access to various resources that it needs. In general, the resources are functionality provided by other services.

The negotiation typically comprises a number of stages. For example, in the preferred embodiment of the invention, negotiation comprises a discovery phase during which one or more other services capable of providing the required resource are identified; an authentication phase during which the identity of the service requesting access to the resource is verified; an authorization phase during which the service requesting access to the resource acquires permission to access the resource; and an acquisition phase during which the service requesting access to the resource is granted access to the resource and finishes configuring itself to access the resource.

As the services 14 of network 10 become configured, communication channels are established between each service which exports functionality and the service(s) which import that functionality. The communication channels may be considered to extend between the cores 20 associated with the exporting and importing services. Each core 20 manages configuration objects. Each configuration object specifies configuration information for exported or imported functionality associated with a service. Imported configuration objects are leased to local services (i.e. services associated with the same device as core 20). Exported configuration objects may be leased to local services or remote services (i.e. services associated with a different device from core 20).

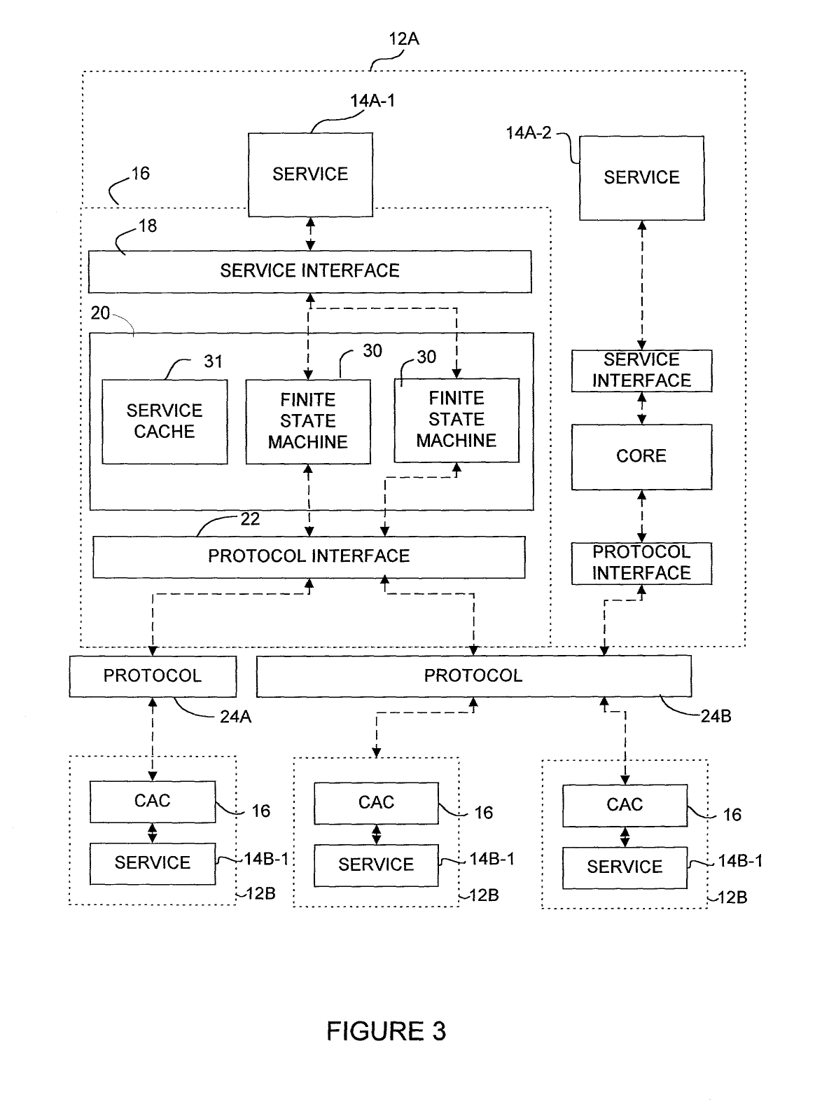

As shown in FIG. 3, core 20 comprises a service cache 32 and one or more finite state machines 30. A finite state machine 30 is provided for each communication channel that terminates at the core 20. Each of the communication channels extends between cores 20. Each core 20 includes a finite state machine associated with each communication channel terminating at that core 20. A finite state machine 30 is provided for each service that is providing functionality to another service and for each service that is importing functionality from another service.

Each finite state machine 30 is initialized in a state which depends upon whether the finite state machine corresponds to an export of functionality or an import of functionality. A finite state machine 30 can change to other states in response to certain events, as described below. A finite state machine 30 which begins in its initial state can reach another state only by passing through all other states intermediate the initialization state and the state reached.

Finite state machines 30 regulate the negotiation process. As described below, finite state machines 30 can be used to implement leasing of resources for specified periods. An architecture which uses finite state machines 30 according to the invention may also be used in the detection and avoidance of deadlock and starvation conditions. This document uses basic definitions and notation for describing finite automata from the text by J. E. Hopcroft and J. D. Ullman entitled Introduction to Automata Theory, Languages and Computation, Narosa Publishing House, New Delhi, 1988 which is hereby incorporated by reference herein. An explanation of the theory which this invention applies is found in Appendix “A”.

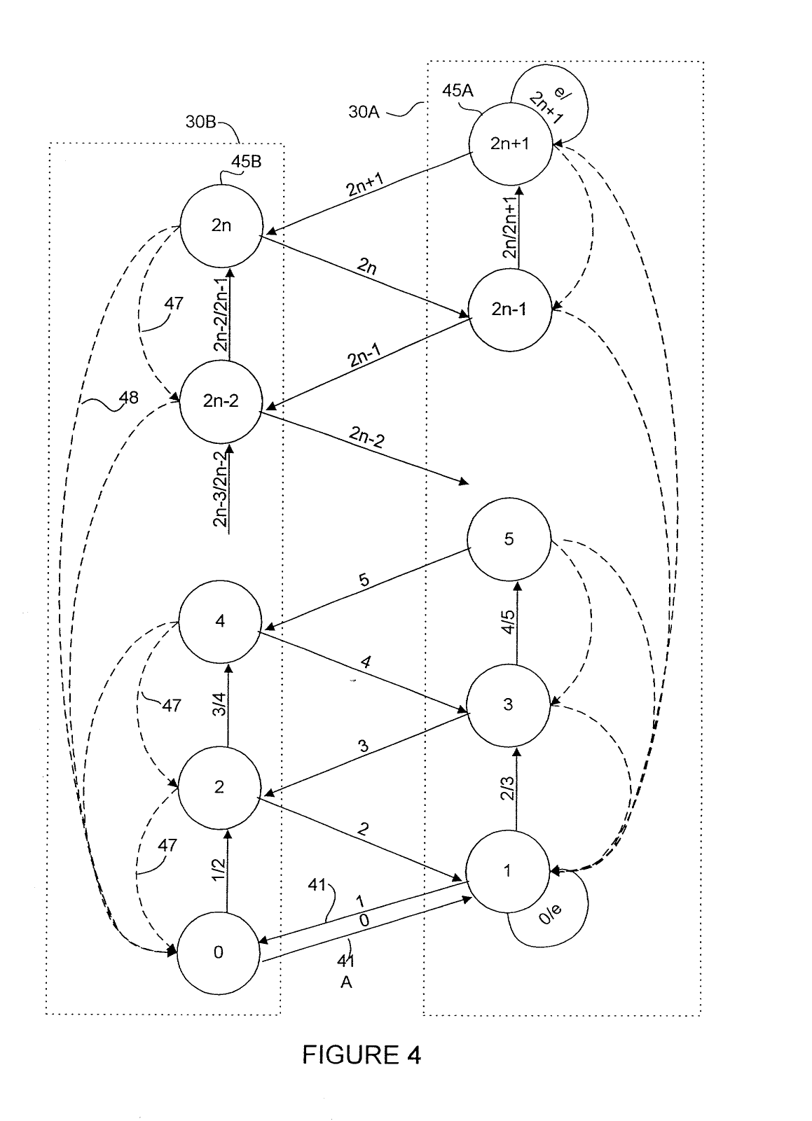

FIG. 4, is a transition diagram which illustrates the states through which two finite state machines 30A and 30B pass while conducting a negotiation for the provision of functionality by a service 14B-1 associated with finite state machine 30B to a service 14A-1 associated with finite state machine 30A. Finite state machine 30A corresponds to a service 14A-1. Finite state machine 30B corresponds to a service 14B-1. In this example, service 14A-1 is hosted on a device 12A and service 14B-1 is hosted on a device 12B. Finite state machine 30B initializes to a state “0” as it represents an export of functionality. Finite state machine 30A initializes to a state “1” as it represents an import of functionality.

In a negotiation involving two finite state machines 30 the output of one finite state machine 30 is provided as input to the other finite state machine 30. Each finite state machine 30 changes to its next state in response to the receipt of a message from another finite state machine 30 with which it is negotiating. The negotiation is considered to be successful if each of finite state machines 30 reaches its final state.

In this example, the states of finite machines 30 are represented by integers. Accessible states for finite state machine 30B are represented by even integers 0, 2, 4, . . . , 2n. Accessible states for finite state machine 30A are represented by odd integers 1, 3, 5, . . . , 2n+1.

In a successful negotiation the states of finite state machines 30 representing the functionality importer and the functionality exporter both increase by twos until each is in a final state. In the process of the negotiation the internal aspect of the messages provides information which cores 20 use to build a configuration object for the functionality being exported or imported. In preferred embodiments of the invention core 20 prevents a service 14 from using imported functionality unless the corresponding finite state machine 30 is in its final state. This may be done by blocking access to the configuration object associated with that imported functionality.

When a finite state machine 30 receives a message it checks the external aspect of the message to see if the message is the correct message to cause a transition of the finite state machine to another state. For example, where the message comprises an XML schema it may check the XML schema for validity. If the message is not valid or is missing required information, it is ignored. If the message is valid then core 20 forwards at least the internal aspect of the message to the associated service 14 via service interface 18 to determine whether the content of the internal aspect of the message is acceptable. If the internal aspect of the message is acceptable then core 20 causes finite state machine to move to its next state. If the internal aspect of the message is not acceptable then core 20 causes finite state machine to move to a lower state from which the negotiation can be continued.

Finite state machines 30 may be realized as Moore machines, in which their outputs are determined by a state of the finite state machine 30 or as Mealy machines, in which their outputs are determined by the most recent transition of the finite state machine 30. For every Moore machine realization there is an equivalent Mealy machine realization.

For example, with reference to FIGS. 3 and 4, when a service 14A-1 is initialized it communicates with core 20 by way of service interface 18. In response, core 20 instantiates finite state machine 30A in state 1. Finite state machine 30A initiates a negotiation for the importation of functionality required by service 14A-1 by sending a message 41 which is received by finite state machine 30B. The internal aspect of message 41 specifies the functionality required by service 14A-1. The external aspect of message 41 specifies that the message is of a type which should cause a 0/2 transition in finite state machine 30B. In response to receiving message 41, finite state machine 30B forwards the internal aspect of message 41 to service 14B-1. If service 14B-1 indicates that the internal aspect of message 41 is acceptable then finite state machine 30B undergoes a transition from its initial state 0 to state 2.

The transition to state 2 causes finite state machine 30B to generate a message 42 (which may include an internal aspect containing information from or related to service 14B-1) and to send message 42 to finite state machine 30A. This process is repeated until each of finite state machines 30A and 30B is in a final state. In the embodiment illustrated in FIG. 4, the final states are states “2n+1” and “2n” respectively. By the time that finite state machines 30A and 30B have reached their final states, they have exchanged all information necessary to permit service 14A-1 to avail itself of the functionality provided by service 14B-1 and the negotiation is successful.

To send messages to one another, finite state machines 30 must have some way to identify each other. In the preferred embodiment of the invention, each device 12 has a unique deviceID, each service 14 has a serviceID which is unique to services in the device 12 hosting the service, each configuration object within a service has an objectID which uniquely identifies the configuration object within its service, and each protocol mechanism includes a unique protocolID. The union of these IDs uniquely identifies every configuration object in network 10.

Each finite state machine 30 can be formally represented as a Mealy machine specified by a six-tuple A=(Q, Σ, Δ, δ, λ, q₀), where Q is a finite set of states, Σ is a finite input alphabet, Δ is the output alphabet, δ: Q×Σ→Q is the transition function, λ is a mapping from Q×Σ to Δ and, q₀ in Q is the initial state. Finite state machines 30 can preferably respond to empty inputs ε by undergoing a transition to an allowed state. This can be represented by defining the transition function δ as δ: Q×{Σ∪ε}→Q.

The behavior of the interaction of a service, such as service 14A-1, with its associated finite state machine 30A can also be modeled as a finite state machine. From the point of view of finite state machine 30B, finite state machine 30A behaves as if it were the sum of an external component

$${A}_{E} = ( {Q}_{E} , {Σ}_{E} , {Δ}_{E} , {δ}_{E} , {λ}_{E} , {q}_{0 E} )$$

having reachable states which are a subset of the non-negative integers and a behavior as described above, and an internal component

$${A}_{I} = ( {Q}_{I} , {Σ}_{I} , {Δ}_{I} , {δ}_{I} , {λ}_{I} , {q}_{0 I} )$$

having reachable states which are a subset of the non-positive integers. The outputs of these two finite state machines satisfy the conditions that:

$${Σ}_{E} = {Σ}_{I} = {Δ}_{E} = {Δ}_{I}$$

and, Q_{I}∪Q_{E}⊂Q_{I}+Q_{E}.

The negative states of the internal component may be equated with error levels produced by the associated service. The zero state of the internal component may be equated with acceptance of the internal aspect of the message. The reachable states of the external component may be equated with the levels of the negotiation.

The sum A_{E}+A_{I} is itself a finite automata having output A_{E}+A_{I}=(Q, Σ, Δ, δ, λ, q₀) in which:

Q=Q_{I}+Q_{E};

Σ is the Cartesian product of the two input alphabets,

$${Σ}_{I} and {Σ}_{E} ;$$

Δ is the Cartesian product of the two output alphabets, Δ_{I} and Δ_{E};

q₀=q_{0I}+q_{0E} is the sum of the initial states;

δ(q, m)=δ(q, (m_{I}, m_{E}))=δ_{I}(q, m_{I})+δ_{E}(q, m_{E}); and,

λ(q, m)=λδ(q, (m_{I}, m_{E}))=(λ_{I}(λ(q, m), m_{I}), λ(δ(q, m), m_{E}).

The condition

$${Σ}_{I} = {Σ}_{E} = {Δ}_{I} = {Δ}_{E}$$

requires the input and output alphabets of each of the finite state machines to be the same. The last condition Q_{I}∪Q_{E}⊂Q_{I}+Q_{E}, is satisfied, for instance, if 0 ε Q_{I}∩Q_{E}.

One can define finite state machine 30 so that:

Q=Σ=Δ={0, 1, . . . ,2n+1}

δ(q₀, ε)=q₀;

δ(q, m)=m+1 if 0≦m≦q+1 and m≦2n;

δ(q, m)=q otherwise;

λ(q₀, ε)=q₀;

λ(q, m)=m+1 if 1≦m≦q+1 and m≦2n; and,

λ(q, m)=ε otherwise.

These conditions hold for all qεQ and all mεΣ∪{ε}.

If this is done and if no error conditions are generated by the associated services then it can be seen that two finite state machines 30A and 30B starting from initial states of 1 and 0 respectively will each negotiate as shown in FIG. 4 until they are in their final states 45A and 45B. With these transition functions, if a finite state machine receives from another finite state machine an output corresponding to an erroneously high state (as could occur, for example, if the finite state machine fails and restarts while the other remains in a higher state) then the finite state machine is prevented from jumping to the high state. The added condition m≦q+1 prevents jumps to a high state. If a finite state machine receives from another finite state machine an output corresponding to a lower state (as could occur, for example, if the other finite state machine is restarted for some reason) then the finite state machine may regress to a lower level. If the internal computation is successful then the negotiation can progress incrementally to higher states. If the internal computation returns a negative result then the negotiation does not progress to a higher level and may regress to a lower level.

This structure has a number of benefits. One is that the system can be readily made to automatically accommodate the failure of a component or communication link. One way to accomplish this is to provide an ε-transition which is executed at various times by finite state machines 30. Preferably the ε-transition is executed periodically. The occurrence of the ε-transition causes finite state machine 30 to return to an earlier state as indicated by line 47. In a preferred embodiment of the invention, occurrence of the ε-transition causes the state of finite state machine 30 to go down by two (i.e. the ε-transition causes the finite state machine 30 to change to its next lower state). This can be represented by the following transition functions for which Q=Σ=Δ={0,1,2, . . . , 2n+1}:

δ(q, ε)=q−2 if 2≦q;

δ(q, m)=m+1 if 1≦m≦q+1 and m≦2n;

δ(q, m)=q otherwise;

λ(q₀, ε)=q₀;

λ(q, ε)=q−2 if 2≦q;

λ(q, m)=m+1 if 1≦m≦q+1 and m≦2n and,

λ(q, m)=ε otherwise.

It can be seen that upon a failure of a link which carries communications between finite state machines 30A and 30B, each of the finite state machines will gradually time-out to its initial state. If a link fails temporarily and then resumes operation then finite state machines 30A and 30B can commence negotiating back toward their final states 45A and 45B from the states that they are in when the communication link is reestablished.

Because of the incremental nature of the negotiation, two negotiating parties will always fall back to the earliest appropriate stage of negotiation. For example, assume that the ε-transitions have moved each of two finite state machines 30 involved in a complex multi-stage negotiation back several steps due to a link failure. When the link is re-established, the two finite state machines 30 will send each other information about their current states. The finite state machine 30 with the higher state will immediately move to the appropriate lower state as defined by the foregoing transition function in order to re-start negotiation.

Providing periodic e-transitions also provides a leasing mechanism. When a finite state machine 30A is in its final state 45A the e-transitions periodically cause it to fall into a previous state. As a result, access to the resource must be periodically renegotiated. Each time a timer expires and executes an e-transition, the negotiation steps toward its initial state. If both negotiating parties are alive, this transition will simply force a re-negotiation of the last stage. If one of the finite state machines 30 or 30A is not accessible from the other (e.g., due to a component or link failure), the remaining finite state machine will begin a march toward its initial state. If a state machine reaches its initial state, the “lease” can be considered to have expired.

The system can cause service caches 31 to contain the addresses of functionality exporters and importers on network 10 by causing the messages 41, and 41A generated from the initial states of finite state machines to be broadcast messages which are received and cached by all cores 20 on network 10. For example, message 41 may comprise an XML requirements schema specifying the type of functionality which a service requires to import. Messages 41A may comprise an XML schema specifying the type of functionality that a service has available for export. Preferably service caches 31 contain preferentially the addresses of functionality exporters and importers which are currently available. Cores 20 maintain service caches 31. Records in service caches 31 may be erased periodically or may be erased upon an unsuccessful attempt to negotiate a connection to a service associated with such a record.

Two conditions which can adversely affect the performance of a computer network are deadlock and starvation. Starvation occurs when a service requires a resource which is not available, either because it is not present or because it is always being used by some other service. Deadlock can occur when there is a cyclic dependency between two or more services.

If every functionality importer maintains a record of all functionality exporters in its service cache 31 and if every functionality importer has a non-zero probability of selecting each functionality exporter then starvation is possible only if there is no potential provider for a service. A system according to the invention may be constructed so as to facilitate the detection of starvation. Starvation can be detected by causing each exporter of functionality to cache all potential consumers of its functionality and vice-versa. If an importer of functionality has a cache empty of providers capable of providing a required service the importer will be starved. The functionality importer can detect this condition by examining its service cache 31.

Even if there is a possible provider of service in the cache then the importer could be starved if the service in question were monopolized by some other importer. However, if the invention is implemented as described below such that each negotiation eventually times out and each service selects other services to negotiate with on the basis of a random draw, then it can be guaranteed that any cached service will become available eventually.

Deadlock can be detected by computing for an entire system the sum:

$$r = {\sum }_{q} ⌊ \frac{q}{2} ⌋ \qquad ( 1 )$$

where q ranges over all finite state machines in the system and the square brackets indicate the integer part. If each pair of negotiating finite state machines 30 implement n rounds of negotiation and there are a total of m pairs of negotiating finite state machines 30 then, when all of the finite state machines 30 associated with negotiations reach their final states, r=2 nm. If r<2 nm for an extended period then it is likely that a deadlock exists within the system. To facilitate the calculation of this sum, preferably each of cores 20 has an interface which makes accessible the value of q for each finite state machine 30 being maintained by that core or at least the sum of q for the finite state machines 30 being maintained by that core 20.

In the preferred embodiment of the invention, functionality importers randomly chose a service capable of providing the required functionality from the list of suitable services in their service cache 31. If a functionality importer fails to acquire the needed resource from a functionality exporter then it randomly chooses another functionality exporter from which to attempt to get the resource.

Most preferably, service exporters also randomly choose the service importers to whom they will export services. With both service importers and service exporters making randomized choices regarding with whom to negotiate, if there is a service exporter on the network capable of providing required functionality to a service importer then the exporter and importer will eventually be able to negotiate for the provision of the required functionality.

In a preferred embodiment of the invention, when a service importer receives a level “0” message, it caches the message. When the service importer requires to import functionality it generates a level “1” message. The level “1” message is cached by service exporters. If a service exporter is at level “0” and receives a level “1” message then it undergoes a transition to level “2” during which it selects a service importer from its cache to attempt to negotiate with. A level “2” message is sent to the selected service importer. If that service importer still requires the service then it will be in level “1”and upon receipt of the level “2” message a negotiation will proceed between the service exporter and the service importer. If the service importer no longer requires the functionality, either because it is negotiating with another service exporter or because its requirement for the functionality has passed then the service importer will not be in its level “1”state and the level “2” message from the service exporter will be ignored and cached.

Further, in this preferred embodiment of the invention the ε-transition occasionally (with a frequency determined by the probability value of p) causes a transition back to the initialization state of each of finite state machines 30. With this combination of features deadlock and starvation can be prevented (unless deadlock or starvation is inherent in the construction of the system). It can be shown that all possible combinations of functionality exporters and functionality importers will be tried at some point. Therefore, if there exists a configuration in which deadlock or starvation does not exist (i.e. if deadlock or starvation are not inherent), the system will eventually find it.

If a functionality importer has a choice of possible functionality exporters then improvements in performance may be achieved by adjusting the process for selecting a functionality exporter to favor functionality exporters which are best suited to provide functionality to the particular functionality importer. For example, the value of a function d which represents a “distance” between the functionality importer and functionality exporter may be used to weight some potential functionality exporters more heavily than others. d may represent, for example, a time for a packet to make a round trip between cores 20 associated with the functionality importer and the functionality exporter. The probability P that a particular functionality provider Bⱼ will be selected may be chosen to be:

$$P ( {B}_{j} ) = \frac{1}{d ( A , {B}_{j} ) ( {\sum }_{i } \frac{1}{d ( A , {B}_{i} )} )} \qquad ( 2 )$$

where A represents a device in its initial state which is drawing from its cache to select a functionality exporter. Note that if there are k possible functionality providers to select from and if d=1 for each of them then the probability that a particular one of the functionality providers will be selected is 1/k. If d is not known for one or more possible functionality exporters then for such exporters d may be chosen to be a suitable positive constant, for example, 1. The selection function of equation (2) tends to bias selection in favor of closer functionality exporters.

The function which determines d also preferably takes into account which functionality exporters have previously provided functionality to the service importer. Most preferably, the value of d is selected so that, all other factors being equal, a service importer will more likely select a service exporter that it has previously successfully imported functionality from than a service exporter that it has not previously successfully imported services from. The value of d may also be selected so that a service importer will tend to be unlikely to select a service exporter with which it has previously unsuccessfully attempted to negotiate for the provision of functionality.

A distance function d may also be used by service exporters to select which service importers they will negotiate with.

The values chosen for a number of parameters including the time intervals between ε-transitions, and the probability that an ε-transition will be to the initial state can affect the performance of a computer network. These parameters may be set to appropriate fixed values. Preferably, however, the values of these parameters are dynamically adjusted. One way to make such dynamic adjustments is to provide a function which indicates whether the parameter in question should be increased or decreased. In response to the value of this function the parameter value can be increased or decreased by appropriate amounts so that it converges to an optimum value. This may be achieved, for example, if a function Θ is available which indicates whether the parameter in question is larger or smaller than a given optimum value as follows:

Θ(x)=−1 if x>y; 0 if x=y; 1 if x<y

where x is the current value of a parameter and y is an optimum value for the parameter. This function can be used in computing an estimate of the unknown parameter x by beginning with an arbitrary value x₀ and then iterating through the following calculation until a suitable estimate has been obtained:

$$\begin{matrix}{x}_{n} = {x}_{n - 1} + cv & if Θ ( {x}_{n - 1} ) > 0 ; \\ {x}_{n} = {x}_{n - 1} - \frac{v}{( c + 1 )} & if Θ ( {x}_{n - 1} ) < 0 ; and , \\ {x}_{n} = {x}_{n - 1} & if Θ ( {x}_{n - 1} ) = 0\end{matrix} \qquad ( 3 )$$

where v and c are suitable chosen constants. For example, v=−1 and c=2 or v=0.5 and c=1.3. In general, v can be initialized to any non-zero value and c can be initialized to any value greater than 1.

In the case of the time t between ε-transitions, one can observe that t should reflect the likelihood that a communication link failure will occur. For example, t should be inversely proportional to the probability of the link failure. If immediately after an ε-transition which causes a finite state machine 30 to drop from its final state to an intermediate state (i.e. a state which is neither the initial state or the final state), the negotiation is successfully concluded with the same other finite state machine 30 then t should be increased. Otherwise, t should be decreased. Increasing and decreasing t are preferably done in accordance with equation (3).

Accordingly, in a preferred embodiment of the invention, each CAC 16 maintains a value for t. A single value of t may be used for all instances of a finite state machine 30 associated with a CAC 16. For each finite state machine 30, CAC 16 maintains a record of at least the immediately previous historical connection to other finite state machines 30. Each time an ε-transition causes a finite state machine 30 to drop into an intermediate state, thereby causing a negotiation to regress, the finite state machine 30 attempts to renegotiate the connection with the same service. If this attempt at renegotiation is successful then CAC 16 increases t. If this attempt is unsuccessful and CAC eventually times out to its initial state and negotiates a connection to another service which provides the required functionality then CAC 16 decreases t. CAC 16 preferably has a data store in which are specified maximum and/or minimum limits for t. If so then CAC 16 increases of decreased t only within the range permitted by the maximum and/or minimum limits.

In the case of the probability p with which an ε-transition will cause a reversion to the initial state for a finite automaton 30, one should recall that p was introduced in order to avoid deadlock and starvation. Therefore p is preferably proportional to probability that deadlock or starvation will occur. This means that if a finite state machine 30 initialized and is subsequently able to immediately renegotiate a state with the same finite state machine to which it had previously connected then p should be decreased. Otherwise, p should be increased. Increasing and decreasing p are preferably done in accordance with equation (3).

Accordingly, in a preferred embodiment of the invention, each CAC 16 maintains a value for p for each instance of a finite state machine 30. For each finite state machine 30, CAC 16 maintains a record of at least one historical negotiation successfully concluded to other finite state machines 30. Each time an ε-transition causes a finite state machine 30 to be initialized, thereby breaking off a negotiation, the finite state machine 30 is initialized and subsequently negotiates a new connection to a service that provides the required functionality. The new connection may wind up being successfully negotiated with the same service involved in the broken negotiation or to a different service. CAC 16 determines whether or not the new connection is negotiated with the same service involved in the broken negotiation. If the new connection is negotiated with the same service involved in the broken negotiation, as indicated by the information in the historical negotiation record, then p is increased. The increase may be by an incremental amount or an amount determined by CAC 16. Otherwise p is decreased by an incremental amount or an amount determined by CAC 16. p, being a probability, is in the range of 0<p≦1. It may be desirable to specify a smaller range for p, in which case, CAC 16 may maintain specified maximum and/or minimum limits for p in a data store. If so then CAC 16 may prevent p from being increased beyond a stored upper limit or decreased below a stored lower limit.

### EXAMPLE

By way of example, the foregoing methods and apparatus may be applied to network configuration tasks such as the configuration of a traffic management configuration object in a http service. Consider, for example, the case of a computer network which includes a gateway to the Internet. The gateway includes a http service. When the http service is initialized it initializes a corresponding finite state machine in level “0”. Upon initialization the finite state machine automatically broadcasts a level “0” message. The level “0” message includes information regarding the capabilities of the http service.

The network also includes a device which hosts a service that requires http services. In this example, the device is a web camera server. When the web camera server becomes initialized in a state which requires http services, it causes a corresponding finite state machine to be initialized in level “1”. The finite state machine broadcasts its level “1” message which includes information describing the http services required by the web camera server.

The traffic manager service receives the level “1” message from the web camera server and caches it in a cache containing the identification of services which have requested http services. The traffic manager service selects a service request from its cache of service requests. In this example, it selects the level “1” message from the web camera server. After verifying that it has the capability to service the request, the traffic manager stores information regarding the requested service in a configuration object and sends a result code to the corresponding finite state machine. The traffic manager service's finite state machine undergoes a transition to its state “2”. In state “2” the finite state machine automatically generates a level “2” response message which indicates that the http service has the configuration functionality sought by the web camera server.

The web camera server receives the level “2” message. This causes its finite state machine to undergo a transition to level “3”. The camera's finite state machine then automatically generates and sends its level “3” message which includes detailed configuration requirements. For example, the level “3” message may include information which specifies that the web camera server needs to have all HTTP traffic destined for camera.armadillolabs.com forwarded to it.

The level “3” message is received by the traffic management service. The http service checks to see whether it can meet the detailed requirements in the level “3” message. If so, it stores information regarding the detailed requirements in the configuration object and issues a suitable result code to the corresponding finite state machine. In response, the finite state machine undergoes a transition to its fourth level.

Upon being initialized in the fourth level, the finite state machine generates a level “4” message which confirms that the requested resources have been allocated for use by the web camera service. Upon receiving the level “4” message the web camera server checks to see that the service is still required and, if so generates a result code for the corresponding finite state machine. This causes the finite state machine at the web camera server to change into its 5^{th} level.

If the finite state machine of the http service times out, it will drop to its state 2 and re-send message “2” thereby forcing the web camera service to re-negotiate its configuration parameters. The time out effectively provides a lease having a duration which depends upon the current value for t.

While the foregoing description has described network configuration as an example application of the methods and apparatus of this invention, those skilled in the art will understand that cores, as described herein, may be used as a general framework for negotiating access to computational resources in a distributed computing environment. In such a case a core may be associated with each resource. Since the structure of each core is essentially independent of the details of what is being negotiated, the use of the invention facilitates the rapid creation and deployment of systems which involve automatically executed negotiation for resources.

The invention may be applied more generally in cases where there exist a number of entities in a distributed computing environment and a communication channel over which the entities can exchange messages with one another. For example, take the case where a first one of the entities requires a succession of two or more sets of parameters from a second entity in order to perform some function. Assume that the acceptability of the parameters in one or more later sets of parameters depends somehow upon successful receipt of the one or more earlier sets of parameters. Each of the series of transactions in which the first entity obtains the parameters that it requires from the second entity can be divided into an external aspect and an internal aspect. The external aspect relates to the position in the sequence of sets of parameters of the set of parameters which is currently being requested or supplied. The internal aspect relates to the parameter(s) which are currently being requested or supplied. With this division one can see that a finite state machine as described above can be provided at each of the entities. The external aspect of the transaction can be an output from the finite state machine at one of the entities which is supplied as input to the finite state machine at the other entity. The finite state machines can automatically moderate an incremental negotiation which, if it successfully reaches a final state, will result in the sequence of required parameters being supplied to the first entity.

FIG. 5 illustrates a general method 100 according to the invention. The method is applied to a negotiation having N stages. For the negotiation to progress from a current stage to the next stage, an appropriate message must be received. The message must contain both appropriate internal information and the appropriate external information to trigger transition of the finite state machine to its next stage. Method 100 begins (step 102) by providing a finite state machine having N states and a checker for checking the validity of the internal information received in a message. The checker may be, for example, integrated with service interface 18. When provided with the internal information from a message the checker determines whether the internal information is acceptable and returns to core 20 a result code which indicates whether the internal information is or is not acceptable.

Method 100 continues by placing the finite state machine to its initial state (step 104 ). Upon finite state machine 30 entering a state, core 20 performs one or more initialization actions (step 106 ). In the preferred embodiment the initialization actions include sending an outgoing message. Step 106 preferably includes obtaining internal information to be included in the message (step 106A), identifying a recipient for the message (step 106B) and formatting and sending the message to the recipient (step 106C). The recipient may be a specific other entity, such as a device, service, group of other services or all other services (in which case the message may be sent as a broadcast message). Step 106B may comprise randomly selecting a recipient from a service cache 31 associated with the core 20 as described above.

Method 100 continues with the reception of an incoming message (step 110 ). The incoming message has both an internal aspect and an external aspect. Method 100 determines if both the internal aspect and the external aspect of the incoming message are appropriate to cause a transition to the next phase of the negotiation step 112. If either the internal or external aspect of the message is not appropriate then the negotiation cannot proceed, and may regress. Step 112 checks the external aspect of the message (step 112A).

Since the negotiation cannot proceed to higher levels unless the external aspect of the message contains the appropriate external information to cause finite state machine 30 to undergo a transition from its current state to a next higher state, step 112 can optionally end if step 112A determines that the external aspect of the message does not contain the appropriate external information. Step 112B forwards the internal aspect of the message to the checker. The checker responds with a result code which indicates whether the internal aspect of the message is complete and acceptable (step 112C). If steps 112A and 112C both indicate that the incoming message is acceptable then finite state machine 30 undergoes a transition to its next higher state. Otherwise, finite state machine 30 either stays in its current state (and method 100 waits for another incoming message) or regresses to a state one or more levels lower than the current state. If in step 112 finite state machine 30 does not undergo a transition another state then finite state machine 30 will eventually time out, as described above.

If finite state machine 30 undergoes a transition then core 20 generates a message. The message comprises an external aspect determined by the state in which the transition has placed finite state machine 30. The message also has an internal aspect supplied by a computational part of the first entity. The computational part receives from core 20 information specifying the state in which the transition has placed finite state machine 30 and supplies appropriate information for inclusion in the internal aspect of the message.

In the preferred embodiment of the invention the external information acceptable to cause finite state machine to undergo a transition to the next higher state are integers. Preferably the result code produced by the checker is an integer which is either zero or negative and the external aspect of the message also comprises an integer. In this case, steps 112A and 112C may comprise, adding the result code produced by the checker to the integer in the external aspect of a received message and supplying the resulting sum as input to the finite state machine 30. Depending upon the current state of the finite state machine 30 and the value of the resulting sum, finite state machine 30 will either: undergo a transition to a next-higher state; not undergo a transition; or, undergo a transition to a lower state.

Preferred implementations of the invention comprise computers running software instructions which cause the computers to execute a method of the invention. The invention may also be provided in the form of a program product. The program product may comprise any medium which carries a set of computer-readable signals containing to instructions which, when run by a computer, cause the computer to execute a method of the invention. The program product may be in any of a wide variety of forms. The program product may comprise, for example, physical media such as magnetic data storage media including floppy diskettes, hard disk drives, optical data storage media including CD ROMs, DVDs, electronic data storage media including ROMs, flash RAM, or the like or transmission-type media such as digital or analog communication links.

Since the overall modes of operation of the finite state machines used in the invention are independent of the particular application, the finite state machines may be implemented in software or hardware.

As will be apparent to those skilled in the art in the light of the foregoing disclosure, many alterations and modifications are possible in the practice of this invention without departing from the spirit or scope thereof.

Where a component (e.g. an assembly, device, circuit, layer etc.) is referred to above, unless otherwise indicated, reference to that component (including a reference to a “means”) should be interpreted as a reference to any component which performs the function of the described component (i.e., that is functionally equivalent), including components which are not structurally equivalent to the disclosed D structure which performs the function in the illustrated exemplary embodiments of the invention. Accordingly, the scope of the invention is to be construed in accordance with the substance defined by the following claims.

[image]

[image]

[image]

[image]

[image]

[image]

[image]

[image]

[image]

[image]

[image]

[image]

[image]

[image]

what is claimed is:

1. A computer-implemented method for conducting a negotiation comprising an exchange of messages between first and second entities, the method comprising:
providing a finite state machine associated with the first entity, the finite state machine having a plurality of states;
maintaining the finite state machine in one of its states matching a stage of a negotiation between the first and second entities;
at the first entity conducting a negotiation with the second entity by exchanging messages with the second entity, each of the messages comprising an external aspect containing information determined by a current state of the finite state machine and an internal aspect.

2. The method of claim 1 comprising receiving at the first entity a message from the second entity, the message comprising an external aspect and an internal aspect and providing the external aspect of the message as input to the finite state machine.

3. The method of claim 2 comprising providing the internal aspect of the message to a checker, receiving a result code from the checker and combining the result code with the external aspect of the second message before providing the external aspect of the message as input to the finite state machine.

4. The method of claim 3 wherein the external aspect of the message comprises an integer and the result code comprises zero or a negative integer.

5. The method of claim 4 wherein the finite state machine has a set of transition functions:
δ(q, m)=m+1 if 0≦m≦q+1 and m≦2n;
δ(q, m)=q otherwise;
λ(q, m)=m+1 if 1≦m≦q+1 and m≦2n; and,
λ(q, m)=ε otherwise
with Q=Σ=Δ={0, 1, . . . , 2n+1}
where Q is a finite set of states, q₀ is an initial one of the Q states, Σ is a finite input alphabet, Δ is an output alphabet; δ: Q×Σ→Q is a transition function, λ is a mapping from Q×Σ to Δ.

6. The method of claim 5 wherein the set of transition functions comprises:
δ(q₀, ε)=q₀; and,
λ(q₀, ε)=q₀;
wherein ε represents an empty input.

7. The method of claim 6 wherein the set of transition functions comprises:
δ(q, ε)=q−2 if 2≦q; and
λ(q, ε)=q−2 if 2≦q.

8. The method of claim 7 comprising periodically providing an ε input to the finite state machine.

9. The method of claim 4 wherein the finite state machine comprises a set of transition functions and the set of transition functions does not permit the finite state machine to undergo any transitions to any state higher than a next-higher state.

10. The method of claim 9 comprising periodically providing an ε input to the finite state machine, and, on a fraction p of the ε inputs provided when the finite state machine is not in its initial state, causing the finite state machine to undergo a transition to the initial state.

11. The method of claim 10 comprising after an ε input causes the finite state machine to undergo a transition to the initial state, determining whether a negotiation is commenced again with the same second entity and, if so, decreasing p.

12. The method of claim 2 wherein the first entity comprises a service the negotiation relates to configuration of the service, and the internal aspect of the received message comprises one or more parameters related to configuration of the service.

13. The method of claim 11 comprising incorporating the parameters into a configuration object for the service.

14. The method of claim 13 wherein the service comprises a network connectivity service.

15. In a computer system comprising a plurality of entities including first and second entities and one or more data communication channels by way of which the entities can exchange messages with one another, a method by way of which the first entity can obtain a sequence of sets of one or more parameters from the second entity, the method comprising:
a) providing first and second finite state machine at the first and second entities respectively, each of the finite state machines having a plurality of states including an initial state and a final state;
b) setting a current state of the first finite state machine to the initial state;
c) generating a message comprising an external aspect and an internal aspect, the external aspect determined by the current state of the finite state machine, the internal aspect containing information specifying a next set of required parameters; and,
d) sending the message to the second entity.

16. The method of claim 15 comprising subsequently receiving at the first entity a response message from the second entity, the response message comprising an external aspect and an internal aspect, the external aspect determined by a current state of the second finite state machine, the internal aspect comprising the next set of required parameters, and providing the external aspect of the response message as input to the first finite state machine.

17. The method of claim 16 comprising passing the internal aspect of the message to a computational part of the first entity.

18. The method of claim 17 comprising receiving a result code from the computational part of the first entity and combining the result code with the external aspect of the response message before providing the external aspect of the response message as input to the first finite state machine.

19. The method of claim 18 comprising allowing the finite state machine to undergo a transition to a new current state in response to the provided input and subsequently repeating the steps of generating and sending a message.

20. The method of claim 15 wherein the computer system comprises a computer network, the entities are associated with devices on the computer network.

21. The method of claim 20 comprising, at the first entity, maintaining a cache comprising information identifying other entities on the network wherein, when the current state of the first finite state machine is the initial state, the method comprises identifying another entity on the network as the second entity by making a random selection of the second entity from the cache.

22. The method of claim 21 comprising evaluating a distance function for each entity in the cache wherein making a random selection of the second entity from the cache comprises weighting each entity in the cache by an amount determined by the distance function for that entity.

23. The method of claim 22 wherein the distance function for another entity is based upon a time taken for a message to be exchanged with the other entity.

24. The method of claim 21 comprising checking for starvation of an entity type on the network by checking the cache of an entity on the network for information identifying entities of the entity type.

25. The method of claim 21 comprising determining a state of each of a plurality of finite state machines on the network and checking for a deadlock condition on the network based on the determined states.

26. The method of claim 21 comprising checking for a deadlock condition on the network by periodically computing the sum
$$r = {\sum }_{q} ⌊ \frac{q}{2} ⌋$$
over all of the finite state machines on the network wherein q is an integer representing the current state of a finite state machine and comparing the sum to a threshold value.

27. The method of claim 26 wherein the threshold value is 2 nm wherein there are m pairs of finite state machines and each of the negotiations can be concluded in n rounds.

28. A networkable device comprising a service and a resource allocation component, the resource allocation component comprising a finite state machine having a plurality of possible states including an initial state and a final state, the resource allocation component configured to make available a resource to the service when the finite state machine is in the final state.

29. The device of claim 28 wherein the device comprises a configuration object for the resource and making the resource available to the service comprises enabling access to the configuration object.

30. The device of claim 29 wherein the finite state machine has a set of transition functions:
δ(q, m)=m+1 if 0≦m≦q+1 and m≦2n;
δ(q, m)=q otherwise;
λ(q, m)=m+1 if 1≦m≦q+1 and m≦2n; and,
λ(q, m)=ε otherwise
with Q=Σ=Δ={0, 1, . . . , 2n+1}
where Q is a finite set of states, q₀ is an initial one of the Q states, Σ is a finite input alphabet, Δ is an output alphabet; δ: Q×Σ→Q is a transition function, λ is a mapping from Q×Σ to Δ.

31. The device of claim 30 wherein the set of transition functions comprises:
δ(q₀, ε)=q₀; and,
λ(q₀, ε)=q₀;
wherein ε represents an empty input.

32. The device of claim 31 wherein the set of transition functions comprises:
δ(q, ε)=q−2 if 2≦q; and
λ(q, ε)=q−2 if 2≦q.

33. The device of claim 32 comprising a timer connected to periodically provide an ε input to the finite state machine.

34. The device of claim 27 wherein the finite state machine has a transition function which does not permit transitions to any state higher than a next-higher state.

35. A resource allocation component for networking a device on a data communication network, the resource allocation component comprising a service cache and a finite state machine corresponding to a service of the device, the finite state machine having a plurality of possible states including an initial state and a final state, the resource allocation component moving the finite state machine to another state upon receiving a message from a corresponding finite state machine and moving the finite state machine to a final state upon receiving a message confirming the availability of a resource needed by the service.
